(19) United States
(12) Patent Application Publication
(10) Pub. No.: US 2026/0126327 A1
(43) Pub. Date: May 7, 2026

(54) APPARATUSES AND METHODS FOR IMPROVING RELIABILITY OF THERMOCOUPLES IN COOLING SECTIONS OF CHANNELS DURING HEATING STAGES

(71) Applicant: CAIHONG DISPLAY DEVICES CO., LTD., Xianyang (CN)

(72) Inventors: Menglong WANG, Xianyang (CN); Hongrong HOU, Xianyang (CN); Wei YANG, Xianyang (CN); Chao YU, Xianyang (CN); Ting LUO, Xianyang (CN)

(73) Assignee: CAIHONG DISPLAY DEVICES CO., LTD., Xianyang (CN)

(21) Appl. No.: 19/436,175

(22) Filed: Dec. 30, 2025

Related U.S. Application Data
(63) Continuation-in-part of application No. PCT/CN2025/115611, filed on Aug. 19, 2025.

(30) Foreign Application Priority Data
Sep. 29, 2024 (CN) 202411374788.2

(51) Int. Cl. G01K 7/02

(52) U.S. Cl. CPC G01K 7/021

(57) ABSTRACT

Provided is an apparatus for improving reliability of a thermocouple in a cooling section of a channel during a heating stage. The apparatus includes a thermocouple and at least one thermocouple sheet installed on a cooling tube body. Each of the at least one thermocouple sheet is provided with a notch, and the notch has a groove structure. A cavity is formed between the notch and the cooling tube body, and a root of the thermocouple is disposed in the cavity. The root of the thermocouple is a temperature measuring point of a welded thermocouple.

### CROSS-REFERENCE TO RELATED APPLICATIONS

This application is a continuation-in-part of International Application No. PCT/CN2025/115611, filed on Aug. 19, 2025, which claims priority to Chinese Patent Application No. 202411374788.2, filed on Sep. 29, 2024, the entire contents of each of which are hereby incorporated by reference.

### TECHNICAL FIELD

The present disclosure relates to a technical field of substrate glass manufacturing, and in particular to apparatus and methods for improving reliability of thermocouples in cooling sections of channels during heating stages.

### BACKGROUND

The hot end technology of substrate glass is a core portion of the preparation of the substrate glass. Each functional zone section of a hot end equipment has its own different process settings. The internal temperature of most regions of the main body of the hot end equipment typically exceeds 1400° C., requiring stable long-term operation. A thermocouple serves as an essential basic component of the hot end equipment for temperature monitoring and process control. Different numbers and positions of thermocouples are generally designed according to different structures and materials of the functional zone sections, respectively. In general, in a high-temperature zone (i.e., a process interval in which the temperature exceeds 1600° C.), the primary issue affecting the thermocouples is material oxidation and volatilization during the long-term operation. By contrast, a low-temperature zone operates relatively constantly, and most thermocouples in the low-temperature zone can meet a service life requirement of more than four years.

A certain number of thermocouples are disposed at a top portion of a cooling section within the low-temperature zone. The thermocouples are primarily configured to monitor a flow rate and a temperature of molten glass ultimately delivered to a forming zone. However, the thermocouples exhibit a high incidence of failure during a heating stage. Statistical analysis of multiple production lines has revealed the basic pattern of thermocouple failure in the low-temperature zone. The thermocouple failure predominantly occurs during a later phase of the heating stage, with temperatures generally concentrated between 900° C. and 1200° C. Furthermore, compared to other portions, the thermocouple failure exhibits a distinctly clustered distribution.

Mechanism analysis has substantially confirmed that the failure of the thermocouples disposed at the top portion of the cooling section relates to collapse deformation and axial expansion displacement of a cooling tube body during a high-temperature empty-tube stage. In the absence of the molten glass within the tube body, the tube material gradually softens under the high temperature, resulting in slow creep collapse. Combined with the simultaneous axial expansion, pronounced local displacement occurs. In addition, the thermocouples located at the top portion are sintered to a filling layer and thus cannot move freely, causing local stress to accumulate and ultimately reach a tensile limit of thermocouple wires of the thermocouples. Accordingly, for the thermocouples located at the top portion of the cooling tube, at the current stage where it is difficult to significantly enhance the strength of the thermocouple wires themselves, the primary solution to the problem lies in maintaining sufficient mobility of the thermocouple wires, so that the thermocouple wires release the tensile stress over a certain distance.

### SUMMARY

One or more embodiments of the present disclosure provide an apparatus for improving reliability of a thermocouple in a cooling section of a channel during a heating stage. The apparatus includes a thermocouple and at least one thermocouple sheet installed on a cooling tube body.

Each of the at least one thermocouple sheet is provided with a notch, and the notch has a groove structure. A cavity is formed between the notch and the cooling tube body. A root of the thermocouple is disposed in the cavity, and the root of the thermocouple is a temperature measuring point of a welded thermocouple.

In some embodiments, a ceramic fiber cloth is provided over the thermocouple sheet.

In some embodiments, a surface area of the ceramic fiber cloth is greater than a surface area of the thermocouple sheet.

In some embodiments, a filling material is provided over the ceramic fiber cloth.

In some embodiments, the notch is a rectangular slit, a slit width of the notch is greater than 1.2 to 1.5 times a diameter of the thermocouple, and the slit width is less than a diameter of the temperature measuring point.

In some embodiments, a length of the notch is within a range of 20 mm to 50 mm.

In some embodiments, the at least one thermocouple sheet includes a plurality of thermocouple sheets, and each of the plurality of thermocouple sheets is provided with the notch.

In some embodiments, the at least one thermocouple sheet is provided with a plurality of notches.

In some embodiments, the at least one thermocouple sheet is welded to the cooling tube body.

In some embodiments, the apparatus further includes a displacement sensor, and the displacement sensor is disposed at one end or both ends of the notch.

In some embodiments, the apparatus further includes a processing unit, and the processing unit is configured to: obtain a displacement data sequence of the thermocouple from the displacement sensor; determine a plurality of velocity values of movement of the thermocouple based on the displacement data sequence; determine a motion linearity of the movement of the thermocouple according to the plurality of velocity values; in response to determining that the motion linearity is greater than a preset threshold, generate, based on a sensing temperature of the thermocouple and the plurality of velocity values, a corrected temperature through a preset rule.

In some embodiments, the at least one thermocouple sheet is provided with a stress sensing module, and the stress sensing module is configured to measure a strain of the at least one thermocouple sheet.

In some embodiments, both ends of the notch are provided with flexible buffer portions.

One or more embodiments of the present disclosure provide a method for improving reliability of a thermocouple in a cooling section of a channel during a heating stage, adopting the apparatus for improving the reliability of the thermocouple in the cooling section of the channel during the heating stage. The methods may include installing the at least one thermocouple sheet on the cooling tube body; and placing the thermocouple at the notch of the at least one thermocouple sheet. When the thermocouple is subjected to expansion or sagging of the cooling section, the notch having the groove structure allows the thermocouple to release a displacement amount, thereby improving the reliability of the thermocouple.

In some embodiments, the method for improving reliability of a thermocouple in a cooling section of a channel during a heating stage further includes: disposing a displacement sensor at one end or both ends of the notch; collecting a displacement data sequence of the thermocouple through the displacement sensor; and predicting a probability of abnormality of the thermocouple based on the displacement data sequence through a failure prediction model.

One or more embodiments of the present disclosure provide a computer-readable storage medium, the storage medium stores computer instructions, and when a computer reads the computer instructions in the storage medium, the computer executes the method for improving the reliability of the thermocouple in the cooling section of the channel during the heating stage.

The present disclosure discloses the apparatus and the method for improving the reliability of the thermocouple in the cooling section of the channel during the heating stage. By providing the notch in the thermocouple sheet and disposing the thermocouple within the notch having the groove structure, the apparatus effectively solves the fixation problem of the thermocouple, thereby improving the stability and reliability of the thermocouple during operation. The notch is configured with an upward curve, such that a local cavity is formed between the interior of the notch and the cooling tube body. The cavity structure provides sufficient space to allow flexible movement of a welding spot at the temperature measuring point of the thermocouple. The position of the temperature measuring point of the thermocouple is critical to the accuracy of a measurement result. The apparatus precisely disposes the root of the thermocouple (i.e., the temperature measuring point of the welded thermocouple) within the notch, thereby ensuring effective contact between the temperature measuring point and a measured object and improving accuracy of temperature measurement. Furthermore, by adopting a slidable thermocouple structure, large-area damage to a top portion of the thermocouple during the heating stage is effectively mitigated, thereby enhancing the reliability of the thermocouple.

### BRIEF DESCRIPTION OF THE DRAWINGS

The present disclosure is further illustrated by way of exemplary embodiments, which are described in detail with reference to the accompanying drawings. These embodiments are non-limiting, and in these embodiments, the same reference numerals denote the same structures, wherein:

FIG. 1 is a schematic diagram illustrating a cross-sectional view of a root of a thermocouple according to some embodiments of the present disclosure;

FIG. 2 is a schematic diagram illustrating a structure of a thermocouple sheet with a notch having a groove structure according to some embodiments of the present disclosure;

FIG. 3 is a schematic diagram illustrating a structure of an apparatus for improving reliability of a thermocouple in a cooling section of a channel during a heating stage according to some embodiments of the present disclosure; and

FIG. 4 is a schematic diagram illustrating movement of a temperature measuring point of a thermocouple and stress release according to some embodiments of the present disclosure.

In the drawings, 1 represents a cooling tube body, 2 represents a thermocouple sheet, 3 represents a welding spot, 4 represents a thermocouple, 5 represents a notch, 6 represents a ceramic fiber cloth, and 7 represents a filling material.

### DETAILED DESCRIPTION

To more clearly illustrate the technical solutions in the embodiments of the present disclosure, the drawings used in the description of the embodiments will be briefly introduced below. Obviously, the drawings in the following description are merely some examples or embodiments of the present disclosure. For those of ordinary skill in the art, the present disclosure may be applied to other similar scenarios based on these drawings without creative effort. Unless obviously obtained from the context or the context illustrates otherwise, the same numeral in the drawings refers to the same structure or operation.

It should be understood that the terms “system,” “apparatus,” “unit,” and/or “module” used herein are methods for distinguishing components, elements, parts, sections, or assemblies of different levels. However, if other words can achieve the same purpose, the words may be replaced by other expressions.

As shown in the present disclosure and the claims, unless the context clearly indicates an exception, the terms “a,” “an,” “one,” and/or “the” are not specifically singular and may also include plural. Generally, the terms “include” and “comprise” only indicate that clearly identified steps and elements are included, and these steps and elements do not constitute an exclusive list. A method or device may also include other steps or elements.

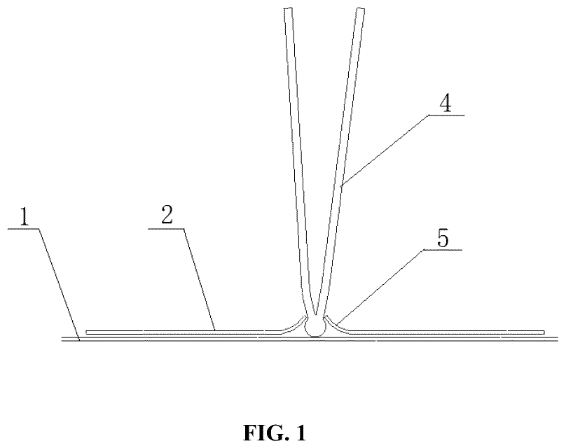

The present disclosure provides an apparatus for improving reliability of a thermocouple in a cooling section of a channel during a heating stage (hereinafter referred to as the apparatus). As shown in FIG. 1 to FIG. 4, the apparatus includes a thermocouple 4 and at least one thermocouple sheet 2 installed on a cooling tube body 1. Each of the at least one thermocouple sheet 2 is provided with a notch 5, the notch 5 has a groove structure. A cavity is formed between the notch 5 and the cooling tube body 1, a root of the thermocouple 4 is disposed in the cavity, and the root of the thermocouple 4 is a temperature measuring point of a welded thermocouple.

A ceramic fiber cloth 6 is provided over the thermocouple sheet 2. A filling material 7 is provided over the ceramic fiber cloth 6. A surface area of the ceramic fiber cloth 6 is greater than a surface area of the thermocouple sheet 2. The at least one thermocouple sheet 2 is welded to the cooling tube body 1 through a welding spot 3. The notch 5 is a rectangular slit, a slit width of the notch is greater than 1.2 to 1.5 times a diameter of the thermocouple 4, and the slit width is less than a diameter of the temperature measuring point. A length of the notch 5 is within a range of 20 mm to 50 mm.

The thermocouple 4 and the notch 5 are designed in the following forms. 1) The at least one thermocouple sheet 2 includes a plurality of thermocouple sheets 2, and each of the plurality of thermocouple sheets 2 is provided with the notch 5. 2) The at least one thermocouple sheet 2 is provided with a plurality of notches 5.

In some embodiments, referring to FIG. 1, FIG. 1 is a schematic diagram illustrating a cross-sectional view of a root of a thermocouple according to some embodiments of the present disclosure. The cooling tube body 1 refers to an equipment functional section that the thermocouple of the present disclosure needs to monitor. For example, the cooling tube body is a precious metal pipeline through which glass flows. The cooling tube body 1 is a flat tube whose cross-section is a nearly elliptical shape. Through the structure of the flat tube, a large heat dissipation area can be achieved, thereby improving overall heat dissipation efficiency, which is also a main function of the cooling section. Precisely due to the special-shaped structure of the cooling section, a support function of a top portion of the cooling tube body 1 is limited. Therefore, during the heating stage, since molten glass has not yet flowed in temporarily, there is no effective support for the cooling tube body 1. When a temperature reaches above 600° C., the top portion of the cooling tube body 1 undergoes slow collapse and deformation. As time prolongs and the temperature further rises, the collapse of the cooling tube body 1 shows an accelerating trend. Meanwhile, high temperature also causes the cooling tube body 1 to expand synchronously along an axial length direction. The above two types (collapse and expansion) of movement of the flat tube together cause a large displacement at a certain point in a top region of the cooling tube body 1.

In summary, three approaches can solve the problem of tensile fracture of the top portion of the thermocouple caused by the collapse and expansion of the flat tube. The first approach is to optimize a structural strength and high-temperature stability of the cooling tube body 1 through manufacturing processing or materials, which has certain technical difficulties, mainly due to industry-specific processes and product performance requirements that impose strict index requirements on the materials. The second approach is to improve a strength of the thermocouple so that the thermocouple has sufficient tensile resistance. Considering size limitations of welded thermocouple wires and external protection devices, and reverse tensile damage that excessive strength may cause to the cooling tube body 1, the strength of the thermocouple wires may only be improved by a small magnitude and still be unable to resist large collapse and expansion forces. The third approach, which is also the approach of the present disclosure, is to design a temperature measuring point or a wire path of the thermocouple to enable the thermocouple wire to have a certain flexibility, so that the thermocouple wire has a function of releasing a tensile force when subjected to the tensile force, thereby achieving stress release of the thermocouple wire through the path process.

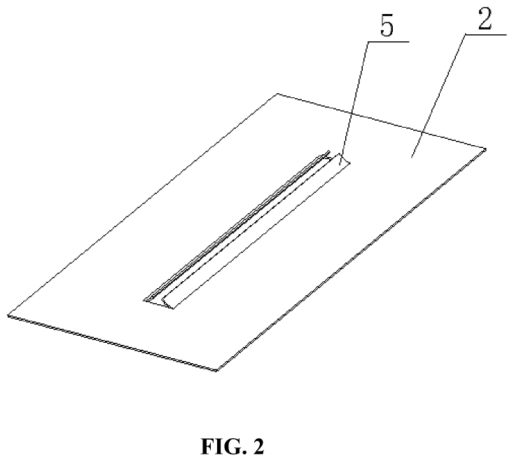

The thermocouple sheet 2 with the notch 5 having the groove structure is an innovative design based on a traditional welded thermocouple sheet. The traditional welded thermocouple sheet mainly functions to form a small buffer platform on a platinum body to be monitored, and also serves as a welding platform for the thermocouple wire, thereby avoiding potential local quality impact on the platinum body caused by directly welding the thermocouple wire onto the platinum body. The thermocouple sheet 2 with the notch having the groove structure of the present disclosure is shown in FIG. 2. The thermocouple sheet 2 is provided with a notch feature that the notch 5 has the groove structure. The notch feature may be manufactured by cutting the middle of a complete rectangular sheet and locally bending, or may be manufactured by a one-time stamping forming manner during a mass production process.

The formed notch feature meets the following requirements. A notch width is greater than 1.2 to 1.5 times a diameter of the thermocouple wire and less than a diameter of a welding spot 3 of the temperature measuring point of the thermocouple. A specific size of the diameter of the welding spot 3 is within a range of 2.5 mm to 3.0 mm. A length of the notch is determined to be within a range of 20 mm to 50 mm based on actual expansion and collapse amounts. If the length is too small, sufficient displacement release can not be achieved. If the length is too large, local deformation of the cooling tube body 1 caused by local deformation can cause bending of a sliding path of the thermocouple, thereby affecting displacement release. Moreover, same temperature measuring points of the thermocouple are also provided in adjacent regions. Therefore, a reasonable range value is set for a design of the length of the notch.

As shown in FIG. 1, the notch is configured with an upward curve, such that a local cavity is formed between the interior of the notch and the cooling tube body 1. The cavity structure provides sufficient space to allow flexible movement of the welding spot 3 at the temperature measuring point of the thermocouple. During an actual heating process of the cooling tube body 1, the collapse and expansion of the cooling tube body 1 that is inclined and distributed cause the cooling tube body 1 to undergo an equivalent backward displacement at the temperature measuring point of the thermocouple. Therefore, during an initial setup, the temperature measuring point of the thermocouple should be placed at a front end of the notch 5 having the groove structure, thereby ensuring sufficient displacement amount.

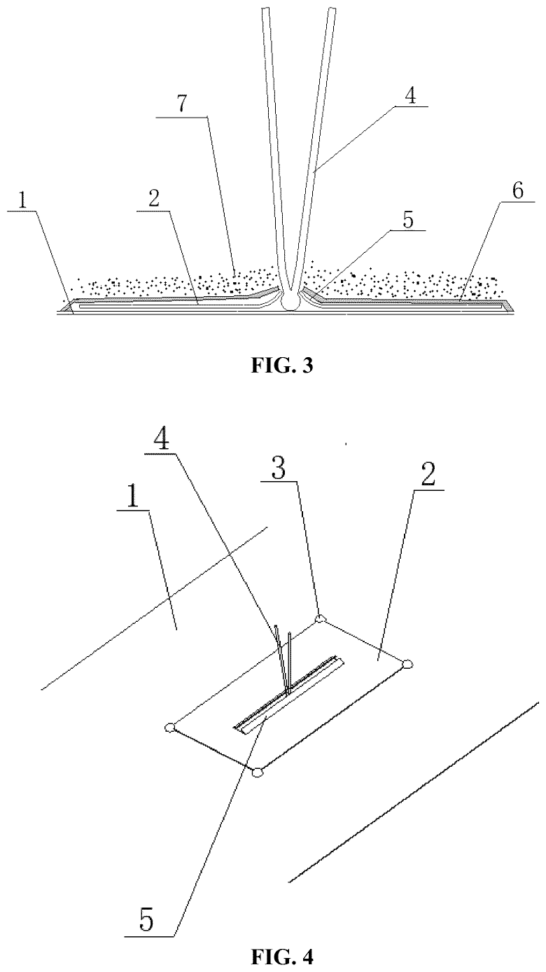

Considering that the outside of the cooling tube body 1 includes the filling material 7, and the filling material 7 actually has a certain binding property at 500° C., this has a fundamental impact on the implementation of the present disclosure. Therefore, it is necessary to add a protective layer that isolates the sintered filling material 7 on the thermocouple sheet 2. As shown in FIG. 3, a layer of the ceramic fiber cloth 6 is laid outside the thermocouple sheet 2. The ceramic fiber cloth 6 does not melt at a high temperature of 1500° C. A main component of the ceramic fiber cloth 6 is aluminum oxide (Al₂O₃), with a content (e.g., a mass content) greater than or equal to 70%, and a thickness of 0.5 millimeters (mm). Before laying the ceramic fiber cloth 6, a slit having a same size as the notch 5 having the groove structure needs to be provided on the ceramic fiber cloth 6 to ensure that an internal thermocouple wire can extend from the slit and can protect the movement of the thermocouple sheet 2 and the temperature measuring point of the thermocouple 4 below. The ceramic fiber cloth 6 has a larger area than the thermocouple sheet 2, thereby ensuring coverage of an entire region of the thermocouple sheet 2.

During the actual heating process, after the temperature of the cooling tube body 1 reaches above 600° C., a displacement caused by a local collapse and an overall expansion begins to occur. At this time, an internally slidable temperature measuring point of the thermocouple may produce a matching displacement under the action of the tensile stress on the thermocouple wire. The principle is shown in FIG. 4. The thermocouple 4 may move along the notch 5 having the groove structure from one relatively low end to the other end until the entire heating process ends, and a position of the thermocouple 4 is finally fixed. Through the manner above, application practice on the cooling tube bodies 1 of various sizes has achieved significant results. A failure rate of the top portion of the thermocouple during the heating stage is reduced by nearly 80%, thereby effectively ensuring process requirements for temperature measurement capability in the region and providing a reliable guarantee for process control of large-flow glass.

In some embodiments, the apparatus further includes a displacement sensor, and the displacement sensor (not shown in the figure) is disposed at one end or both ends of the notch 5.

The displacement sensor refers to a miniaturized device that can convert a position movement amount (displacement) of an object into a signal (e.g., a voltage, a current, an optical signal) that can be measured, transmitted, and processed. A sensor probe is precisely fixed at one end or both ends of the notch, so that an emission/sensing direction of the sensor probe is aligned directly with a slideway region inside the notch 5. For example, the sensor probe is disposed on a base at an end of the notch 5 by using a high-temperature resistant metal bracket and ceramic adhesive, and an angle of the sensor probe to the base is adjusted to ensure that a light spot covers an entire movement range of the welding spot 3. The light spot refers to a light illumination region formed on a surface of the slideway and/or the welding spot 3 by a light signal emitted by the sensor probe of the displacement sensor. The light spot may cover the entire movement range of the welding spot 3, serve as a signal medium to transmit displacement information, and help the displacement sensor capture a movement of the welding spot 3 and convert the movement of the welding spot 3 into a measurable signal. A signal line (e.g., an optical fiber or a cable) drawn from the displacement sensor is protected by a high-temperature resistant sleeve (e.g., a stainless steel flexible tube or a ceramic fiber sleeve) and routed along a safe path of the cooling tube body 1, and finally connected to a signal processing unit (not shown in the figure) away from the high-temperature region.

In some embodiments, the displacement sensor may include an optical fiber displacement sensor and/or an inductive displacement sensor. The optical fiber displacement sensor refers to a sensor that detects the displacement by measuring changes in parameters (e.g., a light intensity, a phase, etc.) of reflected or transmitted light by using characteristics of light propagation in the optical fiber. The inductive displacement sensor refers to a sensor that detects a distance to a measured metal object by measuring a change in inductance of a coil using an electromagnetic induction principle.

In this embodiment, by integrating the miniature displacement sensor, precise monitoring of the displacement of the thermocouple 4 is achieved, and a precise measurement function is added to the original notch structure. By installing the miniature displacement sensor, a sliding displacement amount of the welding spot 3 of the thermocouple in the notch is monitored in real time, and the physical movement is converted into an electrical signal that can be recorded and analyzed.

In some embodiments, the apparatus further includes a processing unit, and the processing unit is configured to obtain a displacement data sequence of the thermocouple from the displacement sensor; determine a plurality of velocity values of movement of the thermocouple based on the displacement data sequence; determine a motion linearity of the movement of the thermocouple according to the plurality of velocity values; in response to determining that the motion linearity is greater than a preset threshold, generate, based on a sensing temperature of the thermocouple and the plurality of velocity values, a corrected temperature through a preset rule.

The processing unit refers to a module or device having a data processing function. For example, the processing unit may be a central processing unit (CPU). In some embodiments, the processing unit may be disposed at a position on the apparatus away from a high-temperature region. For example, the processing unit may be disposed on the filling material 7 or at an upper end of the thermocouple 4. In some embodiments, the processing unit may also be disposed in a cloud, as long as the processing unit can communicate with the thermocouple 4 and other sensors in the present apparatus.

The displacement data sequence refers to a series of position readings collected by the displacement sensor at consecutive time points. Merely by way of example, the displacement data sequence is represented according to Equation (1):

$$P = [ ( t 1 , p 1 ) , ( t 2 , p 2 ) , … , ( tn , pn ) ] , \qquad ( 1 )$$

where P represents the displacement data sequence, t represents a timestamp, p represents a displacement value of a temperature measuring point of the thermocouple sliding along the notch, and n is a positive integer.

The motion linearity refers to a composite indicator used to quantify “smoothness” or “predictability” of the movement of the thermocouple. The higher the value of the motion linearity, the smoother the movement is, and the closer the movement is to a constant speed or a stationary state. The lower the value of the motion linearity, the more violent, irregular, and “non-linearity” the movement fluctuation is.

In some embodiments, the processing unit continuously reads displacement data from the displacement sensor installed near the thermocouple 4 at a fixed sampling rate (e.g., 50 Hz), and stores the displacement data in a buffer region to form a data set of a sliding time window (e.g., the last 2 seconds).

In some embodiments, the processing unit determines a series of instantaneous velocity values by performing numerical differentiation on the displacement data sequence. For example, a difference manner is used to determinate the series of instantaneous velocity values, and the difference manner is represented according to Equation (2):

$$v ( ti ) = ( p ( t i ) - p ( t \{ i - 1 \} ) ) / ( ti - t \{ i - 1 \} ) , \qquad ( 2 )$$

where v(ti) represents an instantaneous velocity value corresponding to a time point ti, and p(ti) represents a displacement value of the temperature measuring point of the thermocouple 4 sliding along the notch 5 at the time point ti. In some embodiments, to make the velocity values smoother and more noise-resistant, a moving average or a more complex filter (e.g., a Kalman filter) may also be used.

Finally, a velocity value sequence within the time window corresponding to the displacement data sequence is obtained. The motion linearity of the movement of the thermocouple 4 is determined based on the plurality of velocity values. Specific manners for determining the motion linearity may include a plurality of manners, for example, the following manners A and B. The velocity value sequence is represented according to Equation (3):

$$V = [ v 1 , v 2 , … , v \{ n - 1 \} ] . \qquad ( 3 )$$

The manner A (based on a standard deviation of velocity) includes determining a standard deviation σv of the velocity value sequence V within the time window. The motion linearity is represented by 1/σv. If the thermocouple 4 moves approximately at a constant speed, the standard deviation σv approaches 0, and the motion linearity is high. If the thermocouple 4 moves sometimes fast and sometimes slow or vibrates, the standard deviation σv increases significantly, and the motion linearity is low.

The manner B (based on an integral of an absolute value of acceleration) includes determining an acceleration sequence A (a differential of the velocity value sequence V, e.g., determined using a difference manner similar to the determination of velocity based on the displacement) based on the velocity value sequence V within the time window, and then an average value or an integral value of the absolute values of acceleration within the time window is determined. For example, the motion linearity is represented by 1/mean(|A|), wherein mean(|A|) represents the average value of the absolute values of acceleration. When the movement is smooth, the acceleration is close to 0, and the motion linearity is high. Any change in the velocity generates the acceleration, and the motion linearity is caused to decrease.

In response to determining that the motion linearity is greater than the preset threshold, a corrected temperature is generated through a preset rule based on the sensing temperature of the thermocouple 4 and the plurality of velocity values. The preset threshold is determined based on a real-time temperature of the cooling tube body 1. The real-time temperature of the cooling tube body 1 refers to the sensing temperature measured by the thermocouple 4. Physical properties of the cooling tube body 1 (a noble metal material)—such as elastic modulus, yield strength, and creep rate—are all closely related to the temperature. In a low-temperature zone (e.g., 400° C.), the cooling tube body 1 has good rigidity, and even relatively large vibrations or accelerations may fall within a normal range. However, in a high-temperature zone (e.g., 1200° C.), the cooling tube body 1 begins to soften. At this point, even slight, irregular movements may indicate serious problems, such as, creep collapse. Therefore, a standard for determining whether the movement is “abnormal” should become stricter as the temperature increases. In some embodiments, the preset threshold is a function Threshold (T) of the temperature T. The processing unit may determine a specific value of the preset threshold through a table lookup manner or a function manner.

The table lookup manner refers to storing a threshold-temperature correspondence table in the processing unit, and then retrieving the threshold according to the current temperature from the threshold-temperature correspondence table. For example, when the temperature T is less than 600° C., the Threshold is equal to 1.5 mm/s². When the temperature T is greater than or equal to 600° C. and less than 1000° C., the Threshold is equal to 0.8 mm/s². When the temperature T is greater than or equal to 1000° C., the Threshold is equal to 0.3 mm/s².

The function manner refers to using a continuous mathematical function to describe this relationship. For example, an inverse proportional function or an exponential decay function is represented by Equation (4):

$$Threshold ( T ) = A / ( 1 + B * T ) or Threshold ( T ) = A * e \hat{} ( - k * T ) + C\_min , \qquad ( 4 )$$

where A, B, k, and C_min represent parameters pre-calibrated based on material properties and experimental data.

The determination manner may include comparing the determined “motion linearity” with the preset threshold. For example, the threshold is set to 0.5 mm/s². If the determined value is greater than the threshold, it means that a current movement of the thermocouple 4 is smooth and predictable (e.g., a movement caused by slow and uniform expansion during the heating process).

If a change in a movement state of the thermocouple 4 is regular, an impact of the change on temperature measurement error may be described using a simple model. The processing unit retrieves the “preset rule” for correction.

The preset rule includes a table lookup manner and a polynomial formula manner.

The table lookup manner (Look-up-Table) refers to storing a table in a memory, and determining the corrected temperature by looking up the table. An index of the table is a velocity value v, and the content of the table is a corresponding temperature compensation value ΔT. The corrected temperature is determined by summing the sensing temperature and the temperature compensation value ΔT(v) obtained by looking up the table. The table is calibrated based on a large amount of preliminary experimental data.

The polynomial formula manner is represented by Equation (5):

$$corrected temperature = sensing temperature + ( c 1 * \vert v \vert + c 2 * {\vert v \vert}^{2} ) , \qquad ( 5 )$$

where c1 and c2 are empirical coefficients obtained by fitting experimental data. The polynomial formula manner expresses that, in a stable sliding, the temperature measurement error is mainly related to the velocity.

In this embodiment, by introducing a core indicator of the motion linearity, a precise distinction between conventional movement and abnormal fluctuations of the thermocouple 4 is achieved. When the thermocouple 4 is in a smooth, predictable movement state (high motion linearity), the processing unit enables an efficient correction manner based on the preset rule. This not only ensures accuracy of temperature data under conventional operating conditions, but also avoids unnecessary complex calculations, thereby saving processing resources, and achieving reliable compensation for basic temperature measurement errors caused by dynamic changes in thermal contact.

In some embodiments, the processing unit is further configured to: in response to determining that the motion linearity is less than or equal to the preset threshold, generate the corrected temperature through a correction model based on the sensing temperature of the thermocouple 4 and the plurality of velocity values. The correction model is a machine learning model.

When the determined motion linearity is less than or equal to the preset threshold, it physically indicates that the thermocouple 4 may be undergoing severe vibrations. The thermocouple 4 may have experienced a “stick-slip” phenomenon. That is, the thermocouple 4 is stuck and then suddenly released, thereby generating an impact acceleration. The cooling tube body 1 may be undergoing abnormal, irregular deformation due to thermal stress or structural issues. In these cases, key factors (e.g., contact pressure, tiny air gaps, etc., between the thermocouple 4 and a tube wall) of heat transfer change rapidly. Simple rules may have failed. Therefore, some embodiments of the present disclosure propose using the correction model for data correction.

The correction model may be a feedforward neural network (FNN), a recurrent neural network (RNN/LSTM), a gradient boosting tree (e.g., XGBoost), or the like, or any combination thereof.

Input data of the correction model includes the plurality of velocity values of the movement of the thermocouple 4 and the sensing temperature of the thermocouple 4 (which may also be a sequence). Output data of the correction model includes the corrected temperature.

In some embodiments, the correction model is obtained through training. Merely by way of example, during a research and development phase, an experimental platform incorporating the present disclosure is built. On the experimental platform, in addition to installing the apparatus, a high-precision, certified reference-level temperature measurement device (e.g., a reference thermocouple precisely implanted at a specific position inside the cooling tube body 1) is used to obtain “true temperature.” Under various simulated operating conditions (including normal heating, rapid temperature changes, application of external vibrations, etc.), displacement data from the displacement sensor, the sensing temperature of the thermocouple of the apparatus, and the “true temperature” from the reference device are recorded synchronously. The recorded massive data is used as a training set. Features extracted from the displacement data and sensing temperature data are used as training samples, and the “true temperature” is used as a label to perform supervised learning training on the machine learning model.

In some embodiments, the processing unit is further configured to transmit the corrected temperature to a user terminal, and/or display the corrected temperature based on a display unit. The user terminal refers to a terminal device used by a user, e.g., a mobile phone, a computer, a tablet computer, etc. The display unit may be a separate display device (e.g., an equipment monitoring large-screen of an enterprise), a display screen integrated on the apparatus, etc.

In some embodiments, the processing unit is configured to: obtain a strain data sequence of at least one thermocouple sheet 2 from a stress sensing module; predict a probability distribution of an abnormality mode of the apparatus based on the strain data sequence through a failure prediction model; and generate prompt information based on the probability distribution of the abnormality mode.

The strain data sequence refers to a series of strain data arranged according to data acquisition time. The strain data refers to measured deformation data of the at least one thermocouple sheet 2.

In some embodiments, the at least one thermocouple sheet 2 is provided with the stress sensing module (not shown in the figures), and the stress sensing module is configured to measure a strain of the at least one thermocouple sheet 2.

In some embodiments, the stress sensing module may be a high-temperature strain gauge. The high-temperature strain gauge refers to a sensitive element that is attached to a surface of an object, and converts tiny deformation (tension or compression) of the object into a change in a resistance value of the object. The high-temperature strain gauge can withstand a high-temperature environment. A flat region on the surface of the thermocouple sheet 2 that may represent overall deformation is selected, and cleaning, polishing, and decontamination are performed on the flat area. A miniature high-temperature strain gauge is precisely attached to a designated position using a dedicated high-temperature resistant adhesive. Then, lead wires are welded, and protected by covering the lead wires with a high-temperature resistant material.

In some embodiments, the stress sensing module may be a resistance measurement module. The resistance measurement module is configured to measure a resistance value of the thermocouple sheet 2. Merely by way of example, the thermocouple sheet 2 is configured as a resistance arm of a measurement circuit. Using a four-wire measurement manner (which can eliminate the influence of a lead wire resistance), a tiny and constant current is applied to the thermocouple sheet 2, and then a voltage drop across two ends of the thermocouple sheet 2 is measured precisely. According to Ohm's law (R=U/I), a change in voltage directly reflects a change in resistance of the thermocouple sheet 2, thereby inferring the strain of the thermocouple sheet 2.

A two-wire measurement manner uses two wires, wherein one wire introduces a current into a resistance (Rx) to be measured, and the other wire draws the current out, while a voltage across the resistance is measured on the two wires. The four-wire measurement manner uses four wires (the resistance measurement module). The four wires are divided into two pairs. One pair of current lead wires (Force+, Force−) is used to provide a pair of constant and precise currents (I) (a current supply sub-module) to the resistance (Rx) to be measured. Another pair of voltage sensing lead wires (Sense+, Sense−) is used to directly measure the voltage drop (U) (a resistance measurement sub-module) generated across two ends of the resistance (Rx) to be measured.

In this embodiment, the thermocouple sheet 2 is upgraded to a structural strain sensor. The thermocouple sheet 2 is upgraded to have a capability to perceive a “stress” level. By measuring the tiny deformation (strain) of the thermocouple sheet 2, a stress on a surface of the cooling tube body 1 is directly reflected, and more direct mechanical data for the failure prediction model is provided, thereby improving prediction accuracy of the failure prediction model.

The failure prediction model is a machine learning model obtained through training, e.g., a deep neural network (DNN) model, a long short-term memory (LSTM) model, etc.

Input data of the failure prediction model includes the strain data sequence and a temperature sequence.

The temperature sequence includes the sensing temperature of the thermocouple 4, which records a temperature of the cooling tube body 1 corresponding to each time point (obtained by the thermocouple 4). In some embodiments, the temperature sequence further includes the corrected temperature described above.

The strain data sequence records a strain of the thermocouple sheet 2 corresponding to each time point.

An output of the failure prediction model is the probability distribution of the abnormality mode. Merely by way of example, the output is in the form of a vector, including a plurality of elements. Each of the plurality of elements corresponds to one abnormality mode, e.g., creep, collapse, etc. Each element value of the vector is within a range of 0 to 1, representing a corresponding probability value. A sum of the element values is 1.

The creep refers to a phenomenon that under sustained high temperature and stress, even if the stress is less than a yield strength, a metal material undergoes slow, continuous plastic deformation over time. The collapse refers to a permanent structural deformation in which the top portion of the cooling tube body 1 sinks downward and becomes unstable due to material creep.

The failure prediction model may be trained in the following manner. Sample data includes a set of historical data including a historical temporal strain sequence and a historical temporal temperature sequence. A label includes an element label value of an actual corresponding abnormality mode of the set of historical data being 1, and element label values of other abnormality modes being 0. A model training manner adopts a gradient descent manner, etc.

In some embodiments, the processing unit generates the prompt information according to the probability distribution of the abnormality mode. Merely by way of example, if a probability of an abnormality mode in the probability distribution of the abnormality mode is greater than a preset abnormality threshold (e.g., 50%), prompt information with a warning is generated to notify management personnel.

In some embodiments, the input of the failure prediction model further includes the displacement data sequence obtained through the displacement sensor. Merely by way of example, corresponding displacement data is added to the sample data during the model training, and a failure prediction model whose input data further includes the displacement data sequence is obtained through the training. Thus, the input data of the failure prediction model has a richer dimension, and the model prediction is more accurate.

In this embodiment, through the failure prediction model, an early warning can be achieved, and an advanced warning message can be issued based on a predictive analysis result before an actual fault occurs or the apparatus is severely damaged.

In some embodiments, both ends of the notch 5 are provided with flexible buffer portions. A flexible buffer portion refers to a flexible structure. The flexible structure may be a structure made by processing a plate into continuous wavy folds. The structure may be compressed or stretched like an accordion when subjected to a force, thereby providing elastic deformation. In some embodiments, a rigid straight wall at an end (i.e., at a maximum displacement limit) of the notch 5 is replaced with a pre-compressed flexible metal sheet or a spring sheet bent inward. One end of an elastic structure (e.g., the spring sheet) is fixed to the main body of the thermocouple sheet 2, and the other end is suspended in the notch 5. When designing the notch 5, an installation position is reserved at the end of the notch 5. A miniature metal sheet made of a high-temperature-resistant Inconel alloy is used to weld one end of the miniature metal sheet to the end of the notch 5, and the other end is a free end. When the welding spot 3 slides over, the welding spot 3 first contacts and compresses the metal sheet.

In some embodiments, the flexible buffer portions may be spring sheets. A structure of a spring sheet is a mechanical component made of a metal sheet (e.g., a spring steel) with excellent elasticity. The structure stores energy and provides an elastic force through its bending deformation. For example, the most common examples are a spring sheet when an automatic ballpoint pen is clicked, or an arc-shaped steel plate providing shock absorption under an old truck seat.

In some embodiments, the flexible buffer portions may be wavy metal sheets. A wavy metal sheet is similar to a wavy metal sheet between a thermos cup liner and an outer housing, or an automatic rebound windproof and soundproof strip under a hotel room door. The wavy metal sheet can return to its original shape after being squeezed.

In this embodiment, a flexible protection is provided by designing a structure of an elastic limiting groove. A mechanical structure of the notch 5 is optimized. A rigid groove wall is changed to an elastic structure, so that when the welding spot 3 of the thermocouple 4 slides to a limiting position, the welding spot 3 receives a buffer force, thereby avoiding an instantaneous impact caused by a rigid collision.

Based on the same inventive concept, the present disclosure provides a method for improving reliability of a thermocouple in a cooling section of a channel during a heating stage. The method includes installing the at least one thermocouple sheet 2 on the cooling tube body 1; and placing the thermocouple 4 at the notch 5 of the at least one thermocouple sheet 2. When the thermocouple 4 is subjected to expansion or sagging of the cooling section, the notch 5 having the groove structure allows the thermocouple 4 to release a displacement amount, thereby improving the reliability of the thermocouple 4.

In some embodiments, a displacement sensor is disposed at one end or two ends of the notch 5, a displacement data sequence of the thermocouple 4 is collected through the displacement sensor, and a probability of abnormality of the thermocouple 4 is predicted based on the displacement data sequence through a failure prediction model. More descriptions regarding the prediction of the probability may be found in the foregoing descriptions, which are not repeated herein.

Therefore, the structure proposed in the present disclosure has the following advantages. 1) The tensile stress of the thermocouple wire is released through a small range of the movement of the root of the thermocouple 4. 2) A surface of the root of the thermocouple 4 is covered with the protective ceramic fiber cloth 6 to keep the root of the thermocouple 4 movable, unaffected by sintering of the surrounding filling material 7. 3) The metal sheet welded to the surface of the cooling tube body 1 is the thermocouple sheet 2, but the metal sheet is different from a thermocouple sheet in a general form, and has the open notch 5 having the groove structure. 4) The at least one metal sheet is used to limit the temperature measuring point of the thermocouple 4. For the at least one temperature measuring point, a form where a plurality of notches are provided on one metal sheet or a plurality of metal sheets form one notch may be adopted simultaneously.

The present disclosure provides an apparatus for improving reliability of a thermocouple in a cooling section of a channel during a heating stage because a conventional thermocouple is not fixed firmly in an application scenario, and is easily displaced or damaged by an external force. By providing the notch in the thermocouple sheet and disposing the thermocouple within the notch having the groove structure, the apparatus effectively solves the fixation problem of the thermocouple, thereby improving the stability and reliability of the thermocouple during operation. The notch is configured with an upward curve, such that a local cavity is formed between the interior of the notch and the cooling tube body. The cavity structure provides sufficient space to allow flexible movement of a welding spot at the temperature measuring point of the thermocouple. The position of the temperature measuring point of the thermocouple is critical to the accuracy of a measurement result. The apparatus precisely disposes the root of the thermocouple (i.e., the temperature measuring point of the welded thermocouple) within the notch, thereby ensuring effective contact between the temperature measuring point and a measured object and improving accuracy of temperature measurement. Furthermore, by adopting a slidable thermocouple structure, large-area damage to a top portion of the thermocouple during the heating stage is effectively mitigated, thereby enhancing the reliability of the thermocouple.

Further, the surface of the root of the thermocouple is covered with the protective ceramic fiber cloth to keep the root of the thermocouple movable, unaffected by sintering of the surrounding filling material.

Further, the length of the notch is determined to be within a range of 20 mm to 50 mm based on actual expansion and collapse amounts. If the length is too small, sufficient displacement release can not be achieved. If the length is too large, local deformation of the cooling tube body 1 caused by local deformation can cause bending of a sliding path of the thermocouple, thereby affecting displacement release. Moreover, same temperature measuring points of the thermocouple are also provided in adjacent regions.

Further, before laying the ceramic fiber cloth, the slit having the same size as the notch having the groove structure needs to be provided on the ceramic fiber cloth to ensure that the internal thermocouple wire is able to extend from the slit and has an ability to protect movement of the thermocouple sheet and the temperature measuring point of the thermocouple below. The ceramic fiber cloth has the larger area than the thermocouple sheet, thereby ensuring the coverage of the entire region of the thermocouple sheet.

Further, the ceramic fiber cloth has characteristics such as high temperature resistance, heat insulation, electrical insulation, etc. The characteristics of the ceramic fiber cloth can effectively block a direct impact of an external high-temperature environment on the thermocouple and the thermocouple sheet, prevent damage to the thermocouple due to an excessively high temperature, and ensure measurement accuracy and stability. The ceramic fiber cloth can also provide a certain buffer effect, thereby reducing damage to the thermocouple and the thermocouple sheet caused by external impact and vibration, and extending service life of the thermocouple and the thermocouple sheet.

Further, the ceramic fiber cloth combined with the filling material can form a good thermal insulation layer. This reduces a heat loss of the cooling tube body, improves energy utilization efficiency, and also prevents interference of ambient temperature changes on temperature measurement of the cooling tube body. The filling material is filled above the ceramic fiber cloth, serving to fix and compact. This can make the ceramic fiber cloth fit to the thermocouple sheet and the thermocouple more closely, thereby preventing the ceramic fiber cloth from loosening or displacing, and ensuring that the thermocouple is always in a correct measurement position. The filling material can also increase stability of the entire apparatus, and reduce shaking or vibration caused by external factors, thereby further improving the reliability of the temperature measurement.

Further, the width of the rectangular slit is greater than 1.2 to 1.5 times the diameter of the thermocouple, so that the thermocouple can be placed into the notch relatively easily. The slit width is less than the diameter of the temperature measuring point. This can effectively prevent the temperature measuring point from sliding out of the notch.

Further, the plurality of thermocouple sheets and the plurality of notches on each of the plurality of thermocouple sheets allow thermocouples to be arranged at different positions, thereby covering different regions of the cooling tube body more comprehensively and obtaining more accurate temperature distribution information. This can avoid measurement errors caused by limitations of a single temperature measuring point, and provide more reliable temperature data for operation and control of the apparatus. If a thermocouple in a certain thermocouple sheet or notch fails, thermocouples in other thermocouple sheets and notches can still continue to operate, thereby reducing an impact on the entire temperature measurement system caused by a single thermocouple failure. The redundant design improves the reliability and stability of the apparatus, thereby ensuring that accurate temperature measurement can be continuously performed during a long-term operation. In different operating scenarios, it may be necessary to focus on monitoring different portions of the cooling tube body, or to perform more precise measurements according to characteristics of temperature changes. The design of the plurality of thermocouple sheets and the plurality of notches can flexibly adjust the arrangement position and the count of the thermocouples to meet different operating conditions and requirements. When maintenance or replacement of the thermocouple is required, the problematic thermocouple in the thermocouple sheet or notch can be selected for processing without affecting a normal operation of other portions. This makes maintenance work more convenient and faster, thereby reducing equipment downtime and maintenance costs.

The basic concepts have been described above. Obviously, to a person skilled in the art, the above detailed disclosure is merely by way of example and does not constitute a limitation to the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe the embodiments of the present disclosure. For example, “an embodiment,” “one embodiment,” and/or “some embodiments” mean a certain feature, structure, or characteristic related to at least one embodiment of the present disclosure. Therefore, it should be emphasized and noted that “an embodiment,” “one embodiment,” or “an alternative embodiment” mentioned two or more times in different locations in the present disclosure does not necessarily refer to the same embodiment. In addition, certain features, structures, or characteristics in one or more embodiments of the present disclosure can be appropriately combined.

In addition, unless explicitly stated in the claims, the order of processing elements and sequences, the use of numbers and letters, or the use of other names in the present disclosure is not used to limit the order of processes and methods of the present disclosure. Although the foregoing disclosure discusses some inventive embodiments currently considered useful through various examples, it should be understood that such details are for illustrative purposes only. The appended claims are not limited to the disclosed embodiments. Instead, the claims are intended to cover all modifications and equivalent combinations that conform to the substance and scope of the embodiments of the present disclosure. For example, although the implementation of various components described above may be embodied in a hardware device, it may also be implemented as a software-only solution, e.g., an installation on an existing server or mobile device.

Similarly, it should be noted that, in order to simplify the expression disclosed in the present disclosure to help understand one or more inventive embodiments, in the foregoing description of the embodiments of the present disclosure, various features are sometimes combined into one embodiment, drawing, or description thereof. However, this disclosure method does not mean that the object of the present disclosure requires more features than those mentioned in the claims. Rather, claimed subject matter may lie in less than all features of a single foregoing disclosed embodiment.

In some embodiments, numbers describing quantities of components or attributes are used. It should be understood that such numbers used to describe the embodiments are modified by the modifiers “about,” “approximately,” or “substantially” in some examples. Unless otherwise stated, “about,” “approximately,” or “substantially” indicates that the stated number allows a variation of ±20%. Accordingly, in some embodiments, the numerical parameters used in the specification and claims are approximate values. The approximate values can change according to the characteristics required by individual embodiments. In some embodiments, the numerical parameters should consider the specified number of significant digits and adopt the method of general digit retention. Although the numerical ranges and parameters used to confirm the breadth of the scope in some embodiments of the present disclosure are approximate values, in specific embodiments, the setting of such numerical values is as precise as possible within a feasible range.

For each patent, patent application, patent application publication, and other materials, such as articles, books, specifications, publications, documents, etc., cited in the present disclosure, the entire contents thereof are hereby incorporated into the present disclosure by reference. Application history documents that are inconsistent with or conflict with the content of the present disclosure are excluded. Documents that limit the broadest scope of the claims of the present disclosure (currently or subsequently attached to the present disclosure) are also excluded. It should be noted that if the description, definition, and/or use of terms in the supplementary materials of the present disclosure are inconsistent with or conflict with the description, definition, and/or use of terms in the present disclosure, the description, definition, and/or use of terms in the present disclosure shall prevail.

Finally, it should be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure can be considered consistent with the teachings of the present disclosure. Accordingly, the embodiments of the present disclosure are not limited to the embodiments explicitly introduced and described in the present disclosure.

1. An apparatus for improving reliability of a thermocouple in a cooling section of a channel during a heating stage, comprising: a thermocouple; and at least one thermocouple sheet installed on a cooling tube body,
wherein each of the at least one thermocouple sheet is provided with a notch, the notch having a groove structure; a cavity is formed between the notch and the cooling tube body; and a root of the thermocouple is disposed in the cavity, wherein the root of the thermocouple is a temperature measuring point of a welded thermocouple.

2. The apparatus of claim 1, wherein a ceramic fiber cloth is provided over the thermocouple sheet.

3. The apparatus of claim 2, wherein a surface area of the ceramic fiber cloth is greater than a surface area of the thermocouple sheet.

4. The apparatus of claim 2, wherein a filling material is provided over the ceramic fiber cloth.

5. The apparatus of claim 1, wherein the notch is a rectangular slit, wherein a slit width of the notch is greater than 1.2 to 1.5 times a diameter of the thermocouple, and the slit width is less than a diameter of the temperature measuring point.

6. The apparatus of claim 1, wherein a length of the notch is within a range of 20 mm to 50 mm.

7. The apparatus of claim 1, wherein the at least one thermocouple sheet includes a plurality of thermocouple sheets, and each of the plurality of thermocouple sheets is provided with the notch.

8. The apparatus of claim 1, wherein the at least one thermocouple sheet is provided with a plurality of notches.

9. The apparatus of claim 1, wherein the at least one thermocouple sheet is welded to the cooling tube body.

10-13. (canceled)

14. A method for improving reliability of a thermocouple in a cooling section of a channel during a heating stage, adopting the apparatus according to claim 1, comprising:
installing the at least one thermocouple sheet on the cooling tube body; and placing the thermocouple at the notch of the at least one thermocouple sheet, wherein when the thermocouple is subjected to expansion or sagging of the cooling section, the notch having the groove structure allows the thermocouple to release a displacement amount thereby improving the reliability of the thermocouple.

15. (canceled)
